(19) United States
(12) Patent Application Publication
(10) Pub. No.: US 2006/0174161 A1
(43) Pub. Date: Aug. 3, 2006

(54) Viewer for test apparatus hardware

(75) Inventor: Yogendra Kumar Sharma, San Jose, CA (US)

Correspondence Address: PATTERSON & SHERIDAN, L.L.P., 3040 POST OAK BOULEVARD, SUITE 1500, HOUSTON, TX, 77056, US

(73) Assignee: Credence Systems Corporation

(21) Appl. No.: 11/049,099

(22) Filed: Feb. 1, 2005

(51) Int. Cl. G06F 11/00

(52) U.S. Cl. 714/38

(57) ABSTRACT

A common viewer framework simplifies the viewer development process and significantly reduces the development time and cost of viewer development. Based on this framework, viewers for different hardware devices are developed according to a common application programming interface (API) and operate as plug-ins to a common viewer tool. Also, the API may be provided as part of a software development kit (SDK) to the maker of the hardware device to be viewed, so that the task of developing viewers can be delegated to the individuals with special knowledge of the hardware devices.

### BACKGROUND OF THE INVENTION

1. Field of the Invention

The present invention relates generally to electronic device testing, and more particularly, to graphical user interface (GUI) tools that are used to view the hardware components of a test apparatus.

2. Description of the Related Art

GUI tools that are known as viewers display the circuit layout of hardware devices and provide interactive control of various parameters and circuit components of the hardware devices. In the field of electronic device testing, these viewers are used during the design and debugging of test programs.

FIG. 1 provides a simplified illustration of a viewer display for a pin drive circuit of a test apparatus. The upper part of the display illustrates the components of the pin drive circuit associated with a selected pin (Pin 1) and voltage values measured at certain points in the circuit. The lower part of the display provides a tabular listing of the voltage values for pin drive circuits associated with all available pins (Pins 14). The ‘#’ next to Pin 1 indicates that the pin drive circuit illustrated in the upper part of the display corresponds to the pin drive circuit for Pin 1. In the circuit diagram, the voltage values are displayed in editable fields to provide the test program designer or debugger, the ability to change the voltage values manually and observe the effects of such changes on other hardware components of the test apparatus.

The actual viewer displays for hardware devices for a test apparatus are generally much more complex than the one shown in FIG. 1. Also, many different viewers are required and it takes time and special knowledge of the various hardware devices of the test apparatus to develop these viewers. Even after a viewer has been developed, the process is not complete, because new viewers have to be developed to work with new hardware devices that are added to the test apparatus and existing viewers have to be modified to work with any hardware device that is modified.

### SUMMARY OF THE INVENTION

The present invention provides a common viewer framework that simplifies the viewer development process and significantly reduces the development time and cost of viewer development. Under this framework, viewers for different hardware devices are developed according to a common application programming interface (API) and operate as plug-ins to a common viewer tool. The API may be provided as part of a software development kit to the maker of the hardware device to be viewed, so that the task of developing viewers can be delegated to the individuals with special knowledge about the hardware devices.

According to an embodiment of the invention, the viewer files for various hardware devices of a test apparatus are stored in a memory unit of the test apparatus. A test program that is loaded into and executed on the test apparatus is configured to recognize the presence of the viewer files for the hardware devices of the test apparatus. This feature facilitates remote viewing of the hardware devices of the test apparatus. As long as the remote access device has the viewer tool installed in it and a network connection to the test apparatus is available, remote viewing would be possible. When the remote connection to the test apparatus is made, the list of available viewer files will be transmitted to the remote access device for display at the remote access device.

By contrast, in conventional viewer systems for a test apparatus, remote viewing is not possible, or otherwise very inconvenient or inefficient, if the viewer files have not been custom-developed and then stored and carried on the remote access device. The conventional viewer systems also require knowledge about the current configuration of the test apparatus.

A viewer display system according to an embodiment of the invention, which is to be connected to an apparatus having a plurality of hardware devices and viewer files associated with the hardware devices, includes a processing unit for executing an interface program that is compatible with each of the viewer files to render a viewer display for one or more of the hardware devices. The interface program is further configured to query the apparatus for a list of viewer files associated with the hardware devices, display the list for selection, retrieve selected viewer files from the apparatus, and then render the viewer display using the selected viewer files.

The apparatus from which viewer files are retrieved may be a test apparatus, which comprises a plurality of test instruments and hardware modules, and a plurality of viewer files associated with the test instruments and hardware modules. The viewer files are defined in accordance with a common set of interface rules such that hardware representations of the test instruments and hardware modules can be rendered on a display device using a common viewer tool.

The viewer display system may be used, for example, to design or debug a test program. A method of designing or debugging a test program according to an embodiment of the invention includes the steps of accessing and displaying a viewer file for a first hardware module using a viewer tool, accessing and displaying a viewer file for a second hardware module using the same viewer tool, and entering inputs using one of the displayed viewer files.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified illustration of a viewer display;

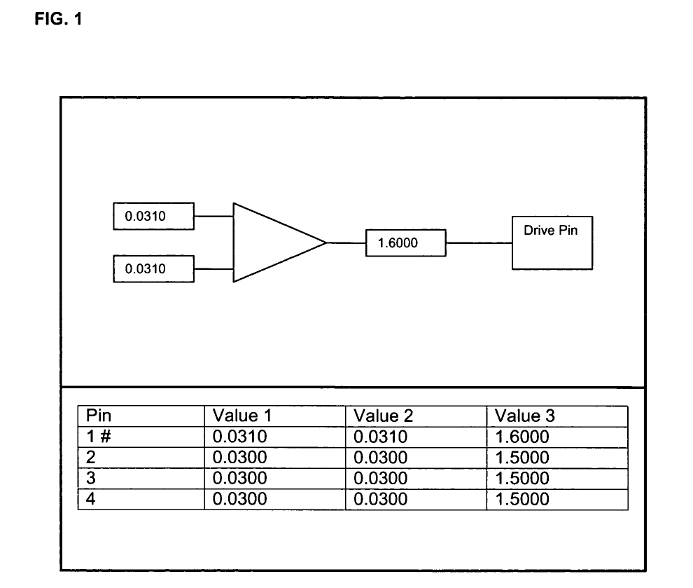

FIG. 2 is a schematic illustration of a common viewer framework employed in various embodiments of the invention;

FIG. 3 is a sample viewer display generated by a viewer display system according to an embodiment of the invention;

FIG. 4 is a block diagram of a viewer display system connected to a test apparatus that implements the common viewer framework;

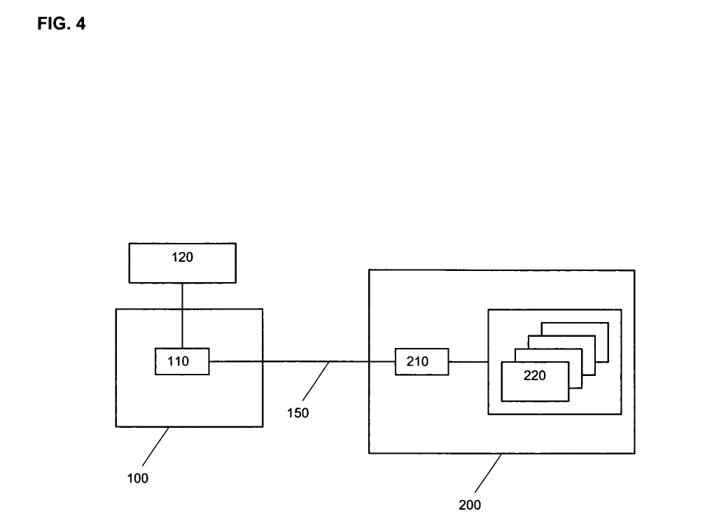

FIG. 5 is a flow diagram illustrating a simplified remote viewing process within the common viewer framework; and

FIG. 6 is a flow diagram illustrating a simplified design or debugging process within the common viewer framework.

### DETAILED DESCRIPTION

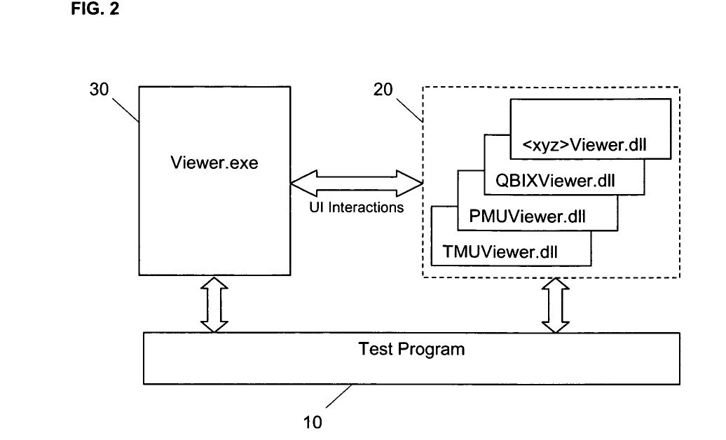

FIG. 2 provides a schematic illustration of the common viewer framework employed in various embodiments of the invention, and illustrate a test program 10, a plurality of viewers 20, and a viewer tool 30. The test program 10 represents the software that controls the components of a test apparatus to carry out a test. Each of the viewers 20 corresponds to a hardware module of the test apparatus and contains a representation of the circuit layout of the hardware module. All of them are developed based on an application programming interface (API) for the viewer tool 30 and are configured as plug-ins for the viewer tool 30. When a viewer is plugged into the viewer tool 30, the viewer tool 30 renders a GUI display in accordance with the contents of the viewer.

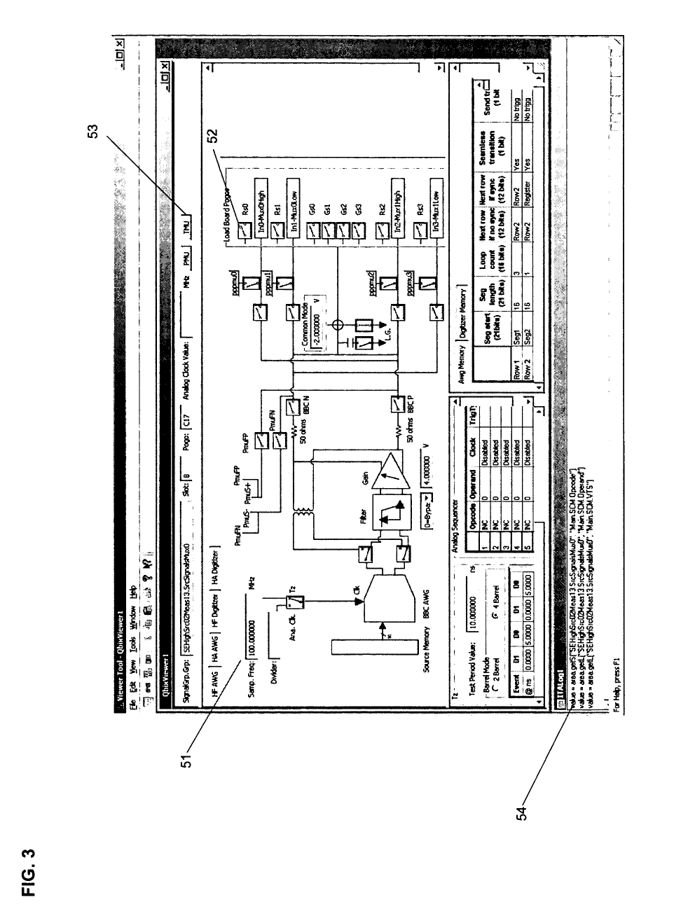

The GUI display or viewer typically includes a circuit layout, tabular listings of various parameters of the circuit and various user input (UI) controls. A sample illustration is provided in FIG. 3. The UI controls may include an input field 51 in which parameter values may be changed, a toggle switch 52 that controls a physical ON/OFF switch of a hardware component (e.g., a relay), or a button 53 that launches a viewer for a sub-module.

When a test is not being executed on the test apparatus, the three elements shown in FIG. 2 represent electronic files. As an example, the test program 10 and the viewer tool 30 are executable files and the viewers 20 are dynamic link library (DLL) files. During execution of a test, the viewers 20 and the viewer tool 30 are interfaced to the test program 10 and communicate with the test program 10 to obtain various event information and test parameter values that are needed in rendering viewer displays. They might also communicate to the test program 10 through this interface, various event information and test parameter values that are pertinent to other components of the test apparatus. For example, when a parameter of a hardware component is changed, the change is communicated to the test program and the test program causes the change to occur in the actual hardware component. The viewers 20 and the viewer tool 30 are interfaced to each other through the API for the viewer tool 30. The information that is communicated between the two includes the contents of the viewer 20 and user inputs made to the viewer display during design or debugging.

FIG. 3 is a block diagram of a viewer display system 100, according to an embodiment of the invention, connected to a test apparatus 200 over a computer network 150 (e.g., LAN, WAN, Internet). The viewer display system 100 includes a processing unit 110 and a display unit 120. The processing unit 110 is programmed to execute an interface program that implements the functions of the viewer tool 30, e.g., provide an interface to the viewer DLL files, render the viewer display in accordance with a received DLL file, receive inputs through the viewer display, and communicate the inputs to the test program. The display unit 120 corresponds to a physical display device, e.g., a monitor, which provides the viewer display.

The test apparatus 200, according to an embodiment of the invention, includes a processing unit 210 and a plurality of test instruments 220. A test instrument 220 may be associated with a viewer DLL file or may include one or more hardware modules, each of which is associated with a viewer DLL file. For example, the test apparatus that is marketed by Credence Systems Corporation under the Sapphire® mark supports various viewers, and stores associated viewer DLL files for the following components: an analog test instrument known as QBIX (Quad Broadband Integrated Transceiver), major memory structures on digital test instruments, and various sub-components of test instruments including the parametric measurement unit (PMU), timing measurement unit (TMU), and the per-pin PMU (PPPMU). The viewer display shown in FIG. 3 is an example of a QBIX viewer display.

The various viewers are developed using a software development kit (SDK). The SDK is provided to test instrument makers so that viewers are developed by same party that designed the test instrument. With this procedure, the task of developing viewers can be delegated to the individuals with special knowledge about the test instrument. Also, the same SDK is provided to everyone so that all viewers for the test apparatus will be developed to a common viewer platform and can be viewed with a common viewer tool regardless of who is developing the viewers. The SDK includes an executable version of the viewer tool, API for the viewer tool, documentation, drawings, rule files and sample programs to aid the development of specific viewer for a hardware module. The API includes reusable objects for graphical elements (e.g., relays, tables, UI controls, etc.) and non-graphical elements (e.g., elements associated with the communication layer for interfacing with the test program).

The table below sets forth the viewer components provided by the viewer tool (referred to as ViewerShell), various viewer files (referred to as Individual Plugin), and a help file. Further explanations of the viewer components are provided after the list.

| # | Viewer Component | Contained in |
|---|---|---|
| 1 | ViewersListView | ViewerShell |
| 2 | GraphicalView | Individual Plugin |
| 3 | ITATextualView | Individual Plugin |
| 4 | ITALogView | ViewerShell |
| 5 | StatusBar | ViewerShell |
| 6 | ToolBar | ViewerShell |
| 7 | TitleBar/MenuBar | ViewerShell |
| 8 | AboutBox | Help |

ViewerListView. This viewer component provides a list of available plug-ins. There is a tree view option and a list view option. Under the tree view option, the list is provided in a hierarchical manner. Under the list view option, the list is provided as a simple scrollable list.

GraphicalView. This viewer component provides a diagram of the hardware device with GUI controls overlaid on the diagram to enable user interactions. This item is developed using the SDK and becomes the graphical part of the viewer DLL file. There are two approaches for graphical layouts.

The first approach is the preferred approach. It is carried out based on the graphical display generated at compile time of the test program using VisualStudio IDE and entails the following steps:
Start with the bitmap of the drawing.
Use ResourceEditor in the DevStudio.
Use it as a background of a FormView.
Place and layout UI controls (e.g., buttons, relays, input fields, etc.) at the appropriate locations.
Add methods and handlers for each UI control via the IDE.
Edit code of each method.

The second approach is carried out based on the graphical display generated at run time of the test program using VisualStudio IDE and entails the following steps:
Create Graphical display at runtime.
Start with the Metafile version of the drawing.
Parse the location of each control.
Layout UI controls programmatically.
Add Methods and edit code for each method.

ITATextualView. This viewer component provides a textual view of the ITA calls in the drawing. ITA stands for Interface for Tester Abstraction. ITA is the interface into the test program that viewers will interface with to get a value of a specific field on the screen. The textual view will display a variable name for each UI control on the drawing that maps to an ITA call. Textual and graphical views can be invoked in any order and combination. Both views share the same document and are ensured be updated simultaneously on a change in the data.

ITALogView. This viewer component, indicated as 54 in FIG. 3, provides syntactically correct ITA calls to display. The ITA logs for all the plug-ins may be displayed in one consolidated view or may be displayed separately per plug-in. The consolidated view is preferred. The viewer tool is able to save the ITA log(s) to a file.

StatusBar. This viewer component provides various status information about the test apparatus, e.g., whether or not the test program has been loaded. Other examples include current site number corresponding to the location of the viewed hardware device and various standard indicators.

ToolBar. This viewer component provides toolbar with buttons or icons that, when clicked, activate certain functions or methods of the viewer. The toolbar may provide navigation buttons, for example, through which the user can navigate to and view a detailed area and then navigate back to the original view using the “Back” button.

TitleBar/MenuBar. TitleBar shows name of the test program, typically at the top of the viewer display. MenuBar provides a menu of items that, when selected, activate certain functions or methods of the viewer.

AboutBox. This viewer component provides the company information, name of the viewer and version.

The process set forth above in paragraphs [0025] to [0034] can be automated via a wizard that is integrated in VisualStudio.

The test apparatus 200 has slots into which the test instruments 220 are inserted, and is configured with plug-and-play capabilities. Using its plug-and-play capabilities, the test apparatus 200 automatically detects during test program execution (e.g., at the beginning), the instruments that are supported and viewers for those instruments. When a viewer tool is invoked at the viewer display system 100, a list of supported viewers is provided to the viewer display system 100.

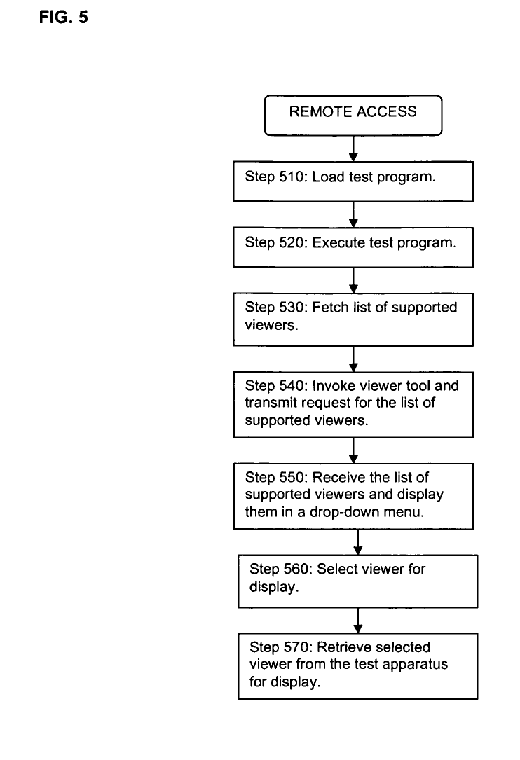

The auto-detect feature facilitates remote viewing of the hardware modules of the test apparatus 200, e.g., where the network connection 150 is over the Internet. The remote viewing process is illustrated in FIG. 5. Steps 510-530 are carried out at the test apparatus 200 and Steps 540-570 are carried out at the viewer display system 100.

In Step 510, the test program is loaded into the processing unit 210 and in Step 520, execution of the test program begins. During test program execution, a list of available viewer DLL files for the test apparatus 200 is generated (Step 530). In Step 540, the viewer tool is invoked at the viewer display system 100, which transmits a request for the list of available viewer DLL files to the test apparatus 200. In Step 550, the list of available viewer DLL files is received by the viewer tool and made available for selection through drop-down menu. After one of the available viewer DLL files is selected using the viewer tool (Step 560), the selected viewer DLL file is retrieved from the test apparatus 200 for display using the viewer tool at the viewer display system 100 (Step 570).

The viewer tool comprises a multiple document interface (MDI) that supports opening of multiple, interdependent viewer windows without launching separate processes. This feature increases usability of the viewer tool during design or debugging of the test program. For example, the effect of a change in a parameter in one viewer can be immediately observed in another viewer whose display is affected by the change. Also, child viewer windows may be spawned from parent viewer windows. In such a case, the MDI features permit concurrent viewing of both the parent viewer window and all of the spawned child viewer windows.

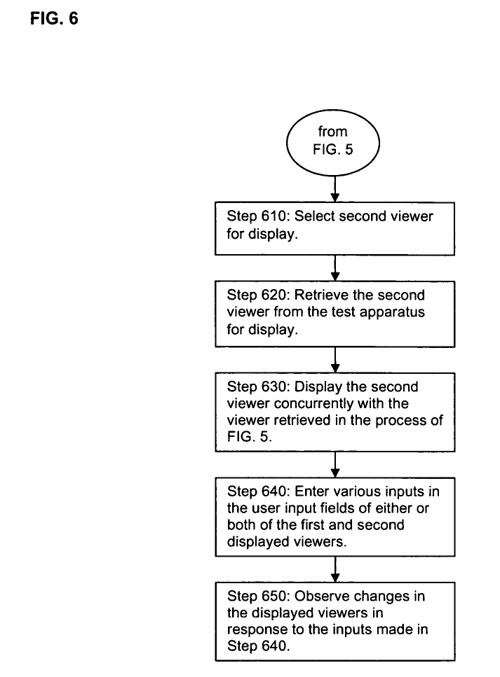

The viewer tool described above may be used during design or debugging of a test program. FIG. 6 provides a very simple illustration of how the viewer tool can be used during design or debugging of a test program. The process illustrated in FIG. 6 is a continuation from the process illustrated in FIG. 5. In Step 610, a second viewer DLL file is selected for display through the same viewer tool. In response, the second viewer DLL file is retrieved from the test apparatus 200 (Step 620) for display concurrently with the first retrieved DLL using the same viewer tool (Step 630). In Step 640, various inputs are entered in the UI fields. Some of these inputs may cause other changes in the first and/or second displayed viewer DLL files. In Step 650, such changes are observed to either confirm that the test program is operating correctly or debug an error in the test program.

While the foregoing is directed to embodiments of the present invention, other and further embodiments of the invention may be devised without departing from the basic scope thereof, and the scope thereof is determined by the claims that follow.

What is claimed is:

1. A viewer display system to be connected to an apparatus having a plurality of hardware devices and viewer files associated with the hardware devices, the viewer display system comprising a processing unit for executing an interface program that is compatible with each of the viewer files to render a viewer display for one or more of the hardware devices.

2. The viewer display system according to claim 1, wherein the interface program is configured to communicate with the viewer files through an application programming interface that has been pre-defined for the interface program.

3. The viewer display system according to claim 1, wherein the interface program is configured to query the apparatus for a list of viewer files associated with the hardware devices and display the list for selection.

4. The viewer display system according to claim 3, wherein the interface program is further configured to retrieve a selected viewer file from the apparatus and then render the viewer display using the selected viewer file.

5. The viewer display system according to claim 1, wherein the viewer display comprises a graphical user interface.

6. The viewer display system according to claim 5, wherein the graphical user interface includes input fields for modifying a parameter of a component of the hardware device.

7. The viewer display system according to claim 1, wherein the connection to the apparatus comprises a connection over a computer network.

8. The viewer display system according to claim 1, wherein the viewer files comprise dynamic link library (DLL) files.

9. A test apparatus comprising:
a plurality of hardware modules; and
a plurality of viewer files associated with said hardware modules, each of said viewer files containing a hardware representation of one of said hardware modules,
wherein the viewer files associated with two or more hardware modules are defined in accordance with a common set of interface rules such that the hardware representations of said two or more hardware modules can be rendered on a display device using a common viewer tool.

10. The test apparatus according to claim 9, wherein the viewer files comprise graphical user interfaces using which inputs are entered.

11. The test apparatus according to claim 10, wherein the inputs comprise a command to modify a physical parameter of a component of a hardware module.

12. The test apparatus according to claim 10, wherein the viewer files comprise DLL files.

13. The test apparatus according to claim 9, further comprising a processing unit programmed to compile a list of available viewer files and retrieve one of the viewer files in response to a request from a remote computer connected to the test apparatus over a computer network.

14. The test apparatus according to claim 13, wherein the processing unit is further programmed to transmit the retrieved viewer file to the remote computer and to receive inputs made through a viewer display generated from the transmitted viewer file from the remote computer.

15. A method of designing or debugging a test program for a test apparatus having a plurality of hardware modules, comprising the steps of:
accessing and displaying a viewer file for a first hardware module that contains a hardware representation of the first hardware module using a viewer tool;
accessing and displaying a viewer file for a second hardware module that contains a hardware representation of the second hardware module using the same viewer tool; and
entering inputs through the displayed viewer file for one of the first and second hardware modules.

16. The method according to claim 15, wherein the inputs comprise a command to modify a parameter of a component of a hardware module.

17. The method according to claim 15, further comprising the step of initiating the viewer tool and transmitting a request for a list of available viewer files prior to the steps of accessing and displaying.

18. The method according to claim 17, wherein the step of accessing a viewer file comprises the steps of requesting a viewer file from the list and receiving the requested viewer file.

19. The method according to claim 15, wherein the steps of displaying and entering are carried out at a remote computer that is connected to the test apparatus over a computer network.

20. The method according to claim 19, wherein the viewer files are displayed at the remote computer concurrently.
